(19) United States
(12) Patent Application Publication
(10) Pub. No.: US 2003/0089255 A1
(43) Pub. Date: May 15, 2003

(54) Flexographic printing machine with alternately manually and automatically adjustable spiral rollers

(76) Inventors: Guenter Rogge, Lienen (DE); Klaus Lapehn, Osnabrueck (DE); Dietmar Koopmann, Lienen-Kattenvenne (DE)

Correspondence Address: JACOBSON HOLMAN PLLC, 400 SEVENTH STREET N.W., SUITE 600, WASHINGTON, DC, 20004, US

(21) Appl. No.: 10/261,948

(22) Filed: Oct. 2, 2002

(30) Foreign Application Priority Data
Nov. 9, 2001 (DE) 10155 256.4

(51) Int. Cl. B41F 13/24

(52) U.S. Cl. 101/248

(57) ABSTRACT

A flexographic printing machine (101) is shown

that is equipped with at least one inking unit (100)

in which (100) the setting of the printing position of the format cylinder (104) and the anilox roller (105) can be achieved by adjusting the format cylinder (104) to the impression roller (103) and the anilox roller (105) to the format cylinder (104) using adjustment equipment. The setting of the printing position of the format cylinder (104) and/or the anilox roller (105) is achieved by manually operating this adjustment equipment (2, 115, 116).

The removal of the format cylinder (104) and/or the anilox roller (105) from the previously manually set position and readjusting these rollers (104, 105) into the same position can be achieved using at least one drive (124).

The invention is a flexographic printing machine as defined in the heading of claim 1 as well as a method to operate the same.

Flexographic printing machines of the type named in the heading in claim 1 are known. Thus, DE 092 09 455 U1 and EP 0 438 716 B1 exhibit machines of this type. These patents also clarify that the adjusting equipment with which force or torque are transferred to the bearings of the anilox roller and of the format cylinder in order to position these rollers can vary in how much they stick out. As a rule, they comprise gears, spindles, grooves, and carriages.

Since in flexographic printing machines it is necessary to position the format cylinder precisely on the impression roller and the anilox roller precisely on the format cylinder, and since this expensive and meticulous adjustment process must be repeated again and again when changing material, when there are tears in the printing sheet, when changing printing blocks or the entire format cylinder, etc., drives that work precisely but rapidly, e.g., stepping motors, are used in these adjusting processes. These drives are very expensive. Thus the purpose of the present invention is to show a flexographic printing machine with which more economical drives can be used.

The purpose is resolved by the characteristic part of claim 1.

Relatively economical motors can then be used as drives. In this connection it is beneficial if such a drive has a stop. This stop can be a component of the gear and, if needed, can also be adjusted when manually adjusting the roller position. At least one of these stops, however, can also be a standard component of the drive. There are even drives that work during operation between two stops and permit only limited turns (for example, 180°).

Additional beneficial embodiments and examples of the embodiment are produced from the additional claims, the concrete description, and the drawings.

The individual figures show:

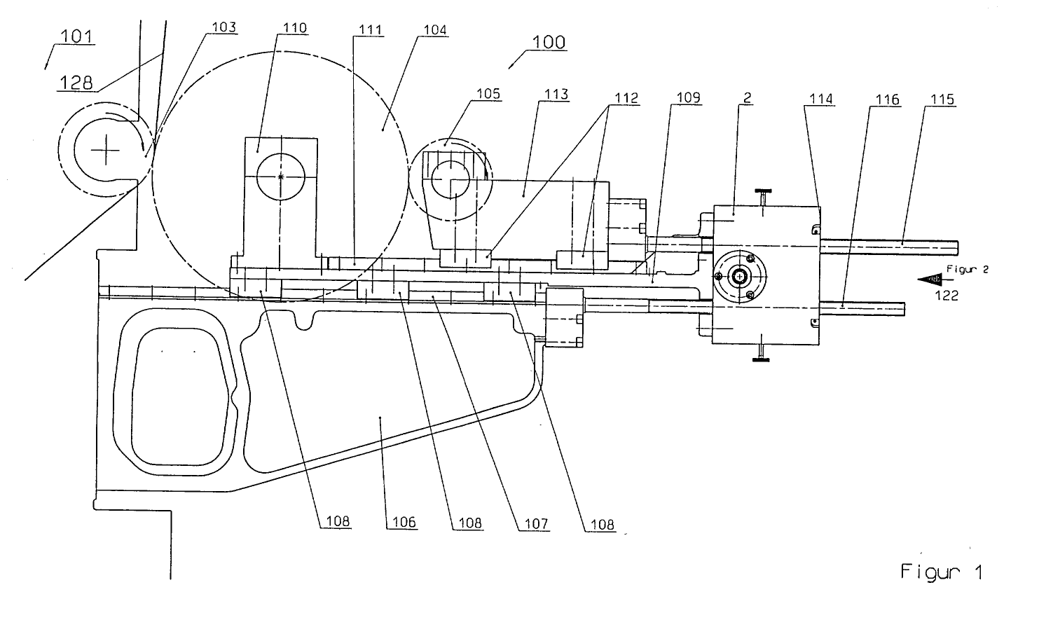

FIG. 1A lateral view of an inking unit of a flexographic printing machine that is equipped with an example of the embodiment of a device consistent with the invention.

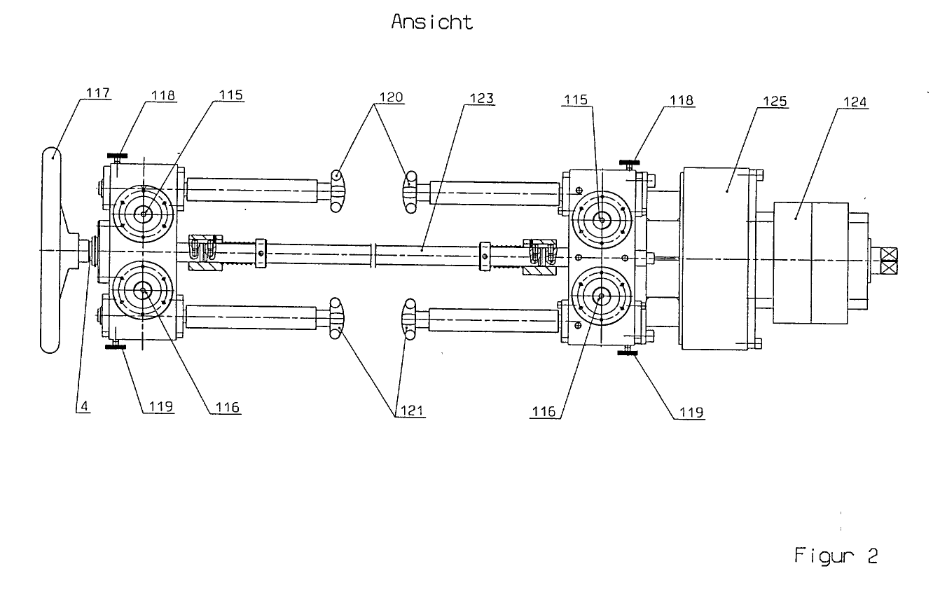

FIG. 2A view of the gear components of the inking unit from the angle of view shown by arrow 122 in FIG. 1.

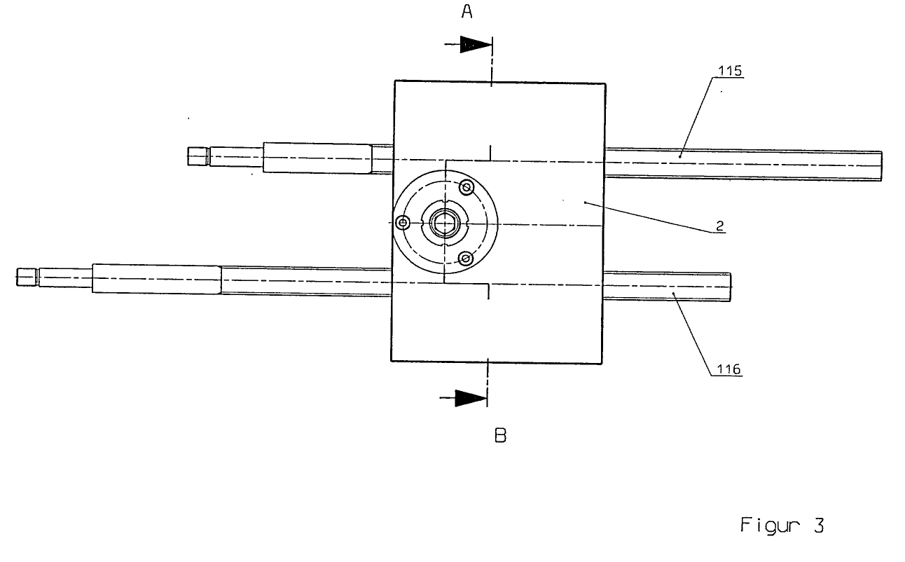

FIG. 3A view of the manually operated side of the gear.

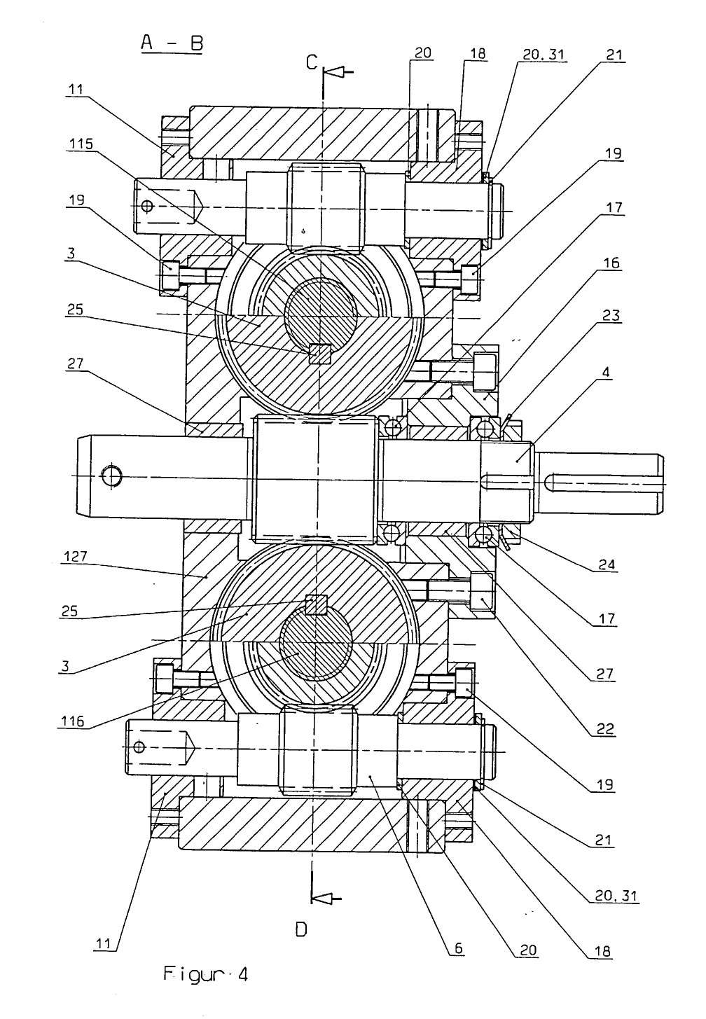

FIG. 4 Section A-B from FIG. 3.

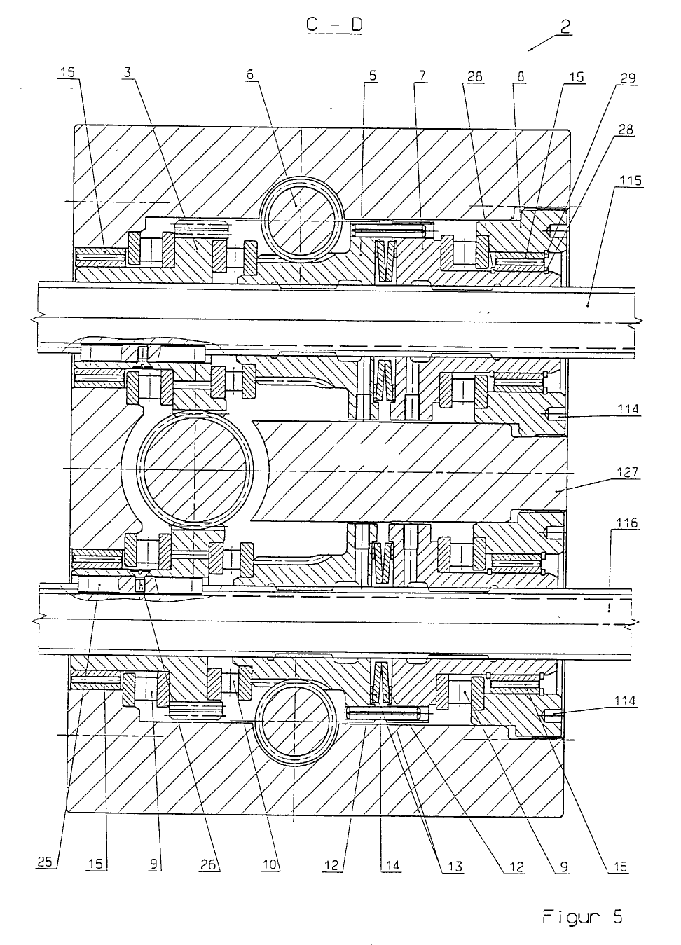

FIG. 5 Section C-D from FIG. 3.

FIG. 1 shows a lateral view of an inking unit 100 of a flexographic printing machine 101 consistent with the invention. The inking unit comprises among other things the format cylinder 104 that is arranged against the impression roller 103 and the anilox roller 105 that is arranged against the format cylinder 104. The components of the inking unit 100 sit on the console of the inking unit 106. The linear guide 107 of the format cylinder is attached directly onto this console. Carriages 108 slide on this linear guide 107, on which carriages the brace 109 of the format cylinder slides over the linear guide 107. This angle brace carries both the bearing 110 of the format cylinder 105 [sic] as well as the linear guides 111 of the anilox rollers, on which in turn the carriages 112 of the anilox rollers slide. For this reason one speaks of a piggyback carriage with such an arrangement.

It is also usual to provide the carriages of both spiral rollers 104, 105 of inking units of flexographic printing machines with angle braces 109, 113, which are handled completely independently from each other.

Such a piece of equipment is not shown by the figures but is nevertheless consistent with the invention if it exhibits the characteristic features of claim 1.

On the carriage 112, the anilox roller 105 is stored in the brace 113. Spindles 115, 116 on the linear guides 107, 111 move both carriages 108, 112. The spindles reach through the gear 2 (FIG. 2). The hand wheel 117 can be recognized on the front end of the gearbox. Both locking screws 118 and 119 serve to specify the precision adjustments 120, 121 for both spindles, which can be seen in FIG. 2.

FIG. 2 is a view of the gear components of the inking unit from the angle of view shown by the arrow 122. The printing unit's elements situated behind the gears 2 seen from the viewing direction are not shown in this figure. FIG. 2 makes clear that both the angle brace 109 of the format cylinder 104 as well as the brace of the anilox rollers are each assigned to 2 spindles 115, 116, which are moved by two gears 2. Both of these gears 2 have been arranged to a great extent as mirror images of each other. The drive of the central helical gear wheels 4 of both gears 2, which are connected by a shaft 123, can however be undertaken both by the hand wheel 117 on the left side of the picture as well as by the drive 124. The drive is achieved pneumatically in the example of the embodiment shown, whereby the drive has a front and a rear stop, which limits the stop motion of the motor. The drive is connected via a coupling 125 with the central helical gear 4 of the right gear 2. The coupling guarantees both the ability of the drive to disconnect from the helical gear as well as the gear's ability to manually rotate 4 when the motor is not running. A cover covers the shaft 123.

FIG. 3 shows once again the manually operable side of the gear 2 and makes clear the position of the carriage A-B that is shown in FIG. 4. FIG. 4 for its part makes clear the position of the carriage C-D that is shown in FIG. 5. The inner mechanism of the gear 2 can be understood in the context of the two last mentioned figures.

What stands out at first is that the gear elements, located above and/or below the central helical gear 4, are designed as mirror images of each other. The setup and/or operation of both spindles 115, 116 is thus done in same way so that only a half of the gear need be described at this point.

Rolling bearings 17 and plain bearings 27 support the central helical gear 4. It 4 is in screw-shaped contact with the gearwheel 3, which is also rotated when the central helical gear wheel is rotated either by the hand wheel 117 or the drive 124.

Here, the axis of rotation of the gear wheel 3 is orthogonal to the axis of rotation of the central helical gear wheel 4. The gear wheel 3 in its rotation also turns the spindle 115 since the parallel key 25 forces both of these gear elements to rotate jointly around their common main inertia axis. This rotation of the spindle 115 in turn results in translational motion of the same 115 since the spindle sits in the nut 5 that is locked in the axial direction.

In the example of the embodiment shown, the rough adjustment of the roller positions is done in the described way, whereby both spindles are moved simultaneously. The precision adjustment of the spindles 115, 116, however, is done individually by manually setting the precision adjustments 120, 121 that drive both screws 6. Each of these two screws in turn is in contact with the spiral gear 5 and the nut 7. Thus, a rotation of the screw 6 around its 6 main inertia axis results in rotation of the spiral gear 5 and the nut 7. Both of the latter components 5, 7 are guided in any case through the cylindrical pin 14 in their circular direction and together form a two-piece nut, which—as already mentioned—cannot be appreciably repositioned in the axial direction of the spindle since it is prevented from such translational motion by the caster roller bearings 9 and 10. These caster roller bearings 9, 10 do permit the rotation of the nuts 5, 7 around their main inertia axis, however.

Rotation of an otherwise stationary, two-piece nut 5, 7 thus results in translational motion of the corresponding spindles 115, 116, which does not rotate when being precision-adjusted this way since otherwise the overall mimicry of the rough adjustment 4, 3, 25 would have to rotate as well. The described translation motion of the spindles stopped in the circular direction during their individually undertaken precision adjustment does not create any force between the mimicry of the rough adjustment 4, 3, 25 and the mimicry of the precision adjustment 6, 7, 5, 14, however, since the mimicry of the rough adjustment does not create any resistance to the translation motion during precision adjustment. On the contrary, the spindles 115, 116 slide along the parallel key 25, which reaches into a nut in the spindles 115, 116 (FIG. 4). The parallel key for its part screwed with the screw 26 onto the gear wheel 3 and is thus also secured against translation motion in the spindles 115, 116.

Also noteworthy is the functioning of the needle roller bearings 15 that can be seen in FIG. 5 and that store the spindles 115, 116 in the box 127 for the gear 2 and/or in the tapped bushings 8 and permit the rotation of the spindles. The tapped bushings 8 can be rotated for their part in a thread in the gearbox 127 in around their main inertia axis. The response rotation is executed by inserting pins from a suitable turning tool into the drill holes 114 in the tapped bushing 8 such that the tapped bushing 8 can be turned with the tool. By turning the tapped bushing 8, the position of the same 8 can be adjusted from outside in the axial direction of the spindle. In this way it is possible, with limited translational motion of the tapped bushing 8, to set the restoring force of the plate springs 13. Suitable restoring force in these springs ensures that the whole gear functions without any play. It may be necessary from time to time to readjust or set the restoring force of the springs.

With such adjustment equipment, the rollers involved in the printing process can be adjusted in the following way:

First, using the hand wheel 17, a rough adjustment of the position of the anilox roller 105 and the format cylinder 104 is made. This rough adjustment can be further improved by operating the precision adjustments 120, 121. The precision adjustment is done individually for the anilox roller 104 and for the format cylinder 105.

The printing process is started in the adjusted position. If after the printing sheet 128 tears there is need to remove the anilox roller and the format cylinder from the impression roller, the torque needed for this is acquired from the drive 124 and transferred via the coupling 125 to the central helical gear. The drive 124 has two integrated and thus not-diagrammed stops at its disposal simultaneously that restrict its torque. Thus, the drive 124 turns the central helical gear 4 around a fixed angle, whereby the rotor of the drive rotates from the front to the rear stop. In this way, the stop movement of the anilox roller and the format cylinder is brought about. After changing sheets, the drive is again operated in the opposite direction, whereby the rotor of the drive again reaches the front stop. In this way, the anilox roller 105 and the format cylinder 104 return to the original, manually set printing position.

List of Reference Numbers

| | |
|---|---|
| 1 | Spindle |
| 2 | Gear |
| 3 | Gear wheel |
| 4 | Helical ear |
| 5 | Spiral gear |
| 6 | Spiral |
| 7 | Nut |
| 8 | Tapped bushing |
| 9 | Caster roller bearing |
| 10 | Caster roller bearing |
| 11 | Flanged housing |
| 12 | Connecting disc |
| 13 | Plate spring |
| 14 | Cylindrical pin |
| 15 | Needle roller bearing |
| 16 | Flanged housing |
| 17 | Roller bearing |
| 18 | Flanged housing |
| 19 | Pan-head screw |
| 20 | Connecting disc |
| 21 | Snap ring |
| 22 | Pan-head screw |
| 23 | Locking plate |
| 24 | Axle nut |
| 25 | Parallel key |
| 26 | Flat-head screw |
| 21 | Porous metal plain bearing |
| 28 | Snap washer |
| 29 | Snap washer |
| 100 | Inking unit |
| 101 | Flexographic printing machine |
| 102 | |
| 103 | Impression roller |
| l04 | Format cylinder |
| l05 | Anilox roller |
| l06 | Console on the inking unit |
| l07 | Linear guide |
| 108 | Format cylinder carriage |
| l09 | Format cylinder angle brace |
| 110 | Format cylinder bearing |
| 111 | Linear guide for the anilox roller |
| 112 | Anilox roller carriage |
| 113 | Anilox roller brace |
| 114 | Drill holes |
| 115 | Format cylinder spindle |
| 116 | Anilox roller spindle |
| 117 | Hand wheel |
| 118 | Locking screw for precision adjustment |
| 119 | Locking screw for precision adjustment |
| 120 | Precision adjustment of anilox roller spindle |
| 121 | Precision adjustment of format cylinder spindle |
| 122 | Arrow |
| l23 | Shaft between helical gears |
| 124 | Drive |
| 125 | Coupling |
| 126 | Cover |
| 127 | Gearbox |
| 128 | Printing sheet |

1. Flexographic printing machine (101),
which is equipped with at least one inking unit (100),
in which (100) the setting of the printing position of the format cylinder (104) and the anilox roller (105) can be achieved by adjusting the format cylinder (104) and the impression roller (103) and the anilox roller (105) up to the format cylinder (104) with adjusting equipment (2, 115, 116, 108, 112, 107, 111),
characterized in that
the adjustment of the printing position of the format cylinder (104) and/or the anilox roller (105) is done by manually operating this adjustment equipment (2, 115, 116, 108, 112, 107, 111) and whereby the removal of the format cylinder (104) and/or the anilox roller (105) can be achieved from the previously manually set position and the readjustment of these rollers (104, 105) into the same position using at least one drive (124).

2. Flexographic printing machine (101) as under claim 1
characterized in that
at least one drive (124) works against at least one stop at least when readjusting, which stop ends the readjustment movement if the position of the format cylinder (104) and the anilox roller (105) is manually positioned up to the impression roller (103).

3. Flexographic printing machine (101) as under one of the foregoing claims
characterized in that
the drive (124) can be separated from the manual operation tools (117, 120, 121) via a coupling (125).

4. Flexographic printing machine as under claims 1, 2, or 3
characterized in that
the drive (124) is a pneumatic drive (124).

5. Flexographic printing machine (101) as under one of the foregoing claims
characterized in that
the manual setting of the position of the anilox roller (105) and the format cylinder (104) can be done jointly.

6. Flexographic printing machine (101) as under one of the foregoing claims
characterized in that
the setting of the position of the anilox roller (105) and the format cylinder (104) can be achieved individually.

7. Flexographic printing machine (101) as under one of the foregoing claims
characterized in that
the removal of the format cylinder (104) and/or the anilox roller (105) from the previously manually set position and the readjustment of these rollers (104, 105) into the same position using a drive (124) can be achieved jointly.

8. Flexographic printing machine (101) as under claims 4 and 6
characterized in that
a central helical gear wheel is provided that works in conjunction with both the drive (124) and the manual operation tools (117) and that passes on the needed force and/or the needed torque to jointly set the roller position.

9. Method for setting the printing position of the format cylinder (104) and the anilox roller (105) of an inking unit (100) of a flexographic printing machine (101) by adjusting the format cylinder (104) to the impression roller (103) and the anilox roller (105) to the format cylinder (104) using adjustment equipment (2, 115, 116, 108, 112, 107, 111)
characterized in that
the setting of the printing position of the format cylinder (104) and/or the anilox roller (105) is achieved by manually operating this adjustment equipment (2, 115, 116, 108, 112, 107, 111) and by
removing the format cylinder (104) and/or anilox roller (105) from the previously manually set position and readjusting these rollers (104, 105) into the same position using at least one drive (124).
